(19) United States
(12) Patent Application Publication
(10) Pub. No.: US 2013/0254457 A1
(43) Pub. Date: Sep. 26, 2013

(54) METHODS AND STRUCTURE FOR RAPID OFFLOADING OF CACHED DATA IN A VOLATILE CACHE MEMORY OF A STORAGE CONTROLLER TO A NONVOLATILE MEMORY

(71) Applicants: Atul Mukker, Suwanee, GA (US); James A. Rizzo, Austin, TX (US); Moby J. Abraham, Lilburn, GA (US)

(72) Inventors: Atul Mukker, Suwanee, GA (US); James A. Rizzo, Austin, TX (US); Moby J. Abraham, Lilburn, GA (US)

(73) Assignee: LSI CORPORATION, Milpitas, CA (US)

(21) Appl. No.: 13/425,698

(22) Filed: Mar. 21, 2012

(51) Int. Cl. G06F 12/16; G06F 12/08

(52) U.S. Cl. 711/103; 711/E12.008; 711/E12.103; 711/E12.017

(57) ABSTRACT

Methods and structure for rapid offloading of cached data in a volatile cache memory of a storage controller to a nonvolatile memory. Features and aspects hereof provide an enhanced storage controller having a volatile cache memory and multiple communication channels each coupled with a corresponding nonvolatile memory device. Responsive to detecting an impending loss of power, control logic of the controller copies data from the volatile cache memory to the multiple nonvolatile memories using the multiple communication channels operating substantially in parallel. Using multiple parallel channels and nonvolatile memory substantially temporally overlapping their operations assures that the cached data can be saved to nonvolatile memory before the controller is inoperable due to power loss. A simple “file system” and error detection and correction codes on the nonvolatile memory help assure that the saved data is valid for return to the volatile memory when power is restored to the controller.

### BACKGROUND

1. Field of the Invention

The invention relates generally to storage controllers and more specifically relates to improved structures and methods to assure that cached data in a volatile cache memory of a storage controller is rapidly offloaded to a suitable non-volatile memory to be saved in case of a power loss.

2. Related Patents

This patent is related to commonly owned U.S. patent Ser. No. 13/365,050 entitled METHODS AND STRUCTURE FOR AN IMPROVED SOLID-STATE DRIVE FOR USE IN CACHING APPLICATIONS which is hereby incorporated by reference. This patent is also related to commonly owned U.S. patent application Ser. No. 13/281,301 entitled METHODS AND SYSTEMS USING SOLID-STATE DRIVES AS STORAGE CONTROLLER CACHE MEMORY. These patent applications are referred to herein as “Sibling” applications.

3. Discussion of Related Art

In high performance, high reliability storage systems, one or more storage controllers (e.g., Redundant Array of Independent Drives—RAID storage controllers) couple to one or more storage devices (e.g., magnetic/optical disk drives and/or solid-state drives) for persistent storage and retrieval of user data. Host systems coupled with the storage controllers issue I/O requests to store data on the storage devices and to retrieve previously stored data from the storage devices. High performance, high reliability storage controllers (such as in RAID storage systems) typically include cache memories used to enhance performance. I/O requests received from the host systems may be quickly completed using the cache memory. Data previously read from the storage devices may be saved in the cache memory and used to quickly satisfy subsequent read request for the same data (completed more quickly than if the data were retrieved again from the storage devices). Similarly, host write requests to store data in the storage system may be completed by storing the supplied write data in the cache memory. The data so stored in the cache memory (e.g., “dirty” data) may be flushed/posted to the storage devices by the storage controller at a later time without delaying continued processing by the host system.

High speed dynamic random access memory (DRAM) components are often used for the cache memory of the storage controller. Since the storage controller may have dirty data in its cache memory, high reliability storage systems often use a battery to retain the contents of the cache memory in case of power failure of the storage controller. If power is lost to the storage controller, the battery assures that the cached data (e.g., the dirty data) will be retained in the cache memory until power is restored to the storage controller. Upon restoration of power to the storage controller, the controller can resume operations with knowledge that the data in its cache memory (e.g., the dirty data) is intact and thus no data will be lost.

Batteries to retain the cached data in the DRAM cache memory can be expensive. The cost of such batteries increases as the size of the memory to be retained increases because the power capacity of the battery must increase accordingly. Further, the length of time the battery must retain the cached data in the cache memory affects the power capacity of the battery and hence the cost of the battery.

Thus it is an ongoing challenge to assure that cached data in a storage controller's cache memory is retained through loss of power to the controller without the added cost of higher capacity batteries.

### SUMMARY

The present invention solves the above and other problems, thereby advancing the state of the useful arts, by providing methods and structure for rapid offloading of cached data in a volatile cache memory of a storage controller to a nonvolatile memory. Features and aspects hereof provide an enhanced storage controller having a volatile cache memory and multiple communication channels each coupled with a corresponding nonvolatile memory device. Responsive to detecting an impending loss of power, control logic of the controller copies data from the volatile cache memory to the multiple nonvolatile memories using the multiple communication channels operating substantially in parallel.

In one aspect hereof, a storage controller comprises a cache memory and control logic coupled with the cache memory. The cache memory is adapted to couple with one or more storage devices. The control logic is further adapted to process I/O write requests received from an attached host system by storing write data associated with the write I/O request in the cache memory. The controller further comprises a first flash memory device, a first communication channel coupling the first flash device with the control logic, a second flash memory device, and a second communication channel coupling the second flash device with the control logic. The control logic is further adapted to detect impending loss of power to the storage controller. The control logic is further adapted, responsive to detecting the impending loss of power, to copy a first portion of data in the cache memory to the first flash memory device through the first communication channel and to copy a second portion of the write data in the cache memory to the second flash memory device through the second communication channel. Communications through the first and second communication channels substantially overlap temporally.

Another aspect hereof provides a method operable in a storage controller such as the above controller. The method comprises detecting an impending power loss to the controller and, responsive to detecting the impending power loss, performing the additional steps. the additional steps comprise copying a first portion of data in the cache memory to a first flash memory device through a first communication channel coupling the controller with the first flash memory device, and copying a second portion of data in the cache memory to a second flash memory device through a second communication channel coupling the controller with the second flash memory device wherein the copying of the first portion and the copying of the second portion substantially overlap temporally.

Yet another aspect hereof provides a method operable in a storage controller such as the above controller. The method comprises detecting an impending power loss to the controller and, responsive to detecting the impending power loss, performing additional steps. The additional steps comprising identifying all dirty data presently in the cache memory and dividing the identified dirty data into multiple segments each segment comprising a substantially similar number of blocks of dirty data. Each segment is associated with a corresponding staging buffer memory of the multiple staging buffer memories. The additional steps further comprise, for each segment, performing further additional steps. The further additional steps comprise storing a header block in the corresponding staging buffer memory. The header block comprising indicia of the number of blocks of dirty data in the segment that follow the header block. The further additional steps also comprise, for each block of dirty data in the segment, performing still further steps. The still further steps comprise generating an error detection and correction code value corresponding with the block of dirty data, appending the block of dirty data and the error detection and correction code value to the staging buffer memory, and copying the staging buffer memory to the corresponding flash memory device through the corresponding communication channel. Processing of the multiple segments substantially overlap temporally.

### BRIEF DESCRIPTION OF THE DRAWINGS

FIG. 1 is a block diagram of an exemplary storage controller enhanced in accordance with features and aspects hereof to offload data from a volatile cache memory of the controller to multiple nonvolatile memory devices of the controller using multiple communication channels of the controller substantially in parallel.

FIG. 2 is a block diagram describing exemplary additional details of an embodiment of the storage controller of FIG. 1.

FIGS. 3 through 6 are flowcharts describing exemplary methods in accordance with features and aspects hereof to offload data from a volatile cache memory to multiple nonvolatile memory devices using multiple communication channels substantially in parallel.

FIG. 7 is a diagram describing an exemplary state machine implementation of methods of FIGS. 3 through 6 in accordance with features and aspects hereof.

### DETAILED DESCRIPTION OF THE DRAWINGS

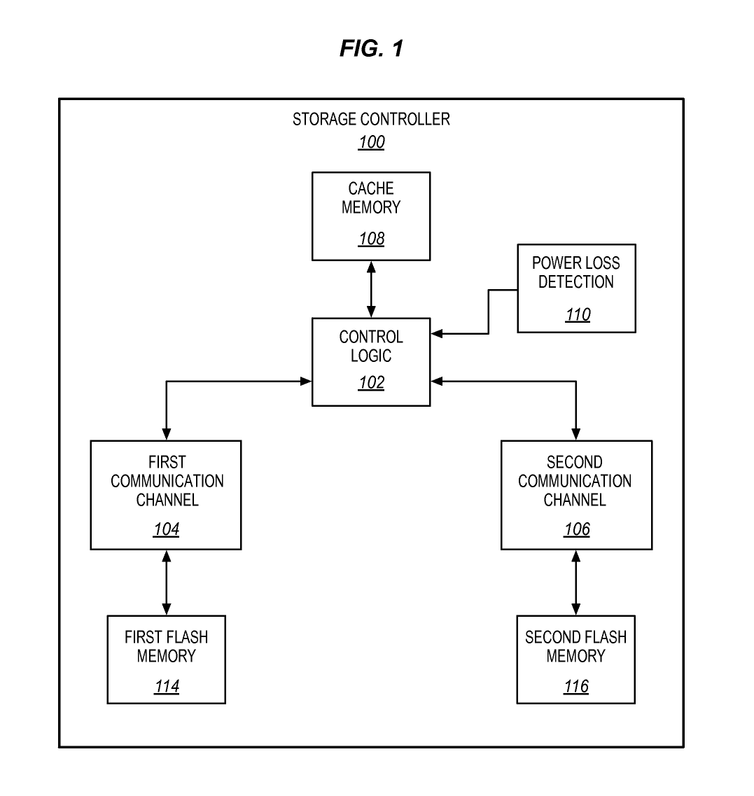

FIG. 1 is a block diagram of an exemplary enhanced storage controller 100 in accordance with features and aspects hereof to offload (copy) cached data from a volatile cache memory to a nonvolatile flash memory device in response to sensing loss of power to the controller. Controller 100 comprises control logic 102 for controlling operations of the storage controller with respect to features and aspects hereof (and optionally to control overall operation of the storage controller for its intended storage management functions). Control logic 102 may comprise one or more general or special-purpose processors and associated program memory storing programmed instructions for performing the functions described herein below. In other embodiments, control logic 102 may comprise suitably designed custom logic circuits for providing the functions described herein below. In still other embodiments control logic 102 may comprise combinations of programmable processors and suitably designed custom logic circuits.

Control logic 102 is coupled with cache memory 108. As is common in high-performance storage controllers, cache memory 108 may be any suitable high-speed memory component of sufficient capacity to provide desired caching functions for data to be written to storage devices (not shown) by controller 100 and read from storage devices by controller 100. In general, cache memory 108 comprises volatile memory components such as DRAM. Control logic 102 is also coupled with first flash memory device 114 through first communication channel 104 and is coupled with second flash memory device 116 through second communication channel 106. First flash memory 114 and second flash memory 116 each comprise suitable nonvolatile memory components such as flash memory components. In some embodiments, first and second flash memories 114 and 116 may also comprise a block oriented controller circuit to interface the memory with the corresponding communication channel and to present the flash memory components as block oriented storage devices. First and second flash memory memories 114 and 116 may be implemented utilizing well-known commercially available flash memory components that incorporate block oriented I/O controllers. Such devices are often referred to as “thumb drives” or “memory sticks”. First and second communication channels 104 and 106 may be any suitable communication media and protocol providing sufficiently high bandwidth to allow rapid copying of information from cache memory 108 to each of first and second flash memory devices one 114 and 116 by operation of control logic 102. In particular, control logic 102 may utilize direct memory access (DMA) circuitry to provide high-speed transfer of information from cache memory 108 to each of first and second flash memories 114 and 116. In some exemplary embodiment, first and communication channels 104 and 106 may each comprise a universal serial bus (USB) communication channel.

Controller 100 further comprises power loss detection 110 adapted to detect impending power loss to controller 100. In some embodiments power loss detection 110 may comprise a simple comparator circuitry that generates a signal when the power applied to controller 100 drops below a predefined threshold voltage. Typically, the threshold voltage may be set sufficiently high that the power loss detection signal may be applied to control logic 102 with sufficient time left (sufficient voltage for a sufficient time) for control logic 102 to rapidly offload information from cache memory 108 into first and second flash memories 114 and 116. Thus, the structure of controller 100 permits saving the contents volatile cache memory 108 into nonvolatile first and second flash memories one 114 and 116 before the loss of power to the controller results in an associated loss of data stored in cache memory 108.

In the exemplary embodiment of FIG. 1, control logic 102 is coupled with two flash memories 114 and 116, each through a corresponding communication channel 104 and 106. By separating a first portion of cached data to be copied from memory 108 into first flash memory 114 and a second portion to be copied into second flash memory 116, each through independent communication channels, control logic 102 may rapidly offload data from volatile cache memory 108 into nonvolatile flash memories 114 and 116. The portions copied to each flash memory device may be apportioned from the cache memory in any suitable manner. The portions may be substantially equal in size or may vary in size as a matter of design choice.

Any number of flash memory components and corresponding communication channels may be present in embodiments of controller 100. To attain required performance for copying dirty data from volatile memory into nonvolatile memory before loss of power renders the control inoperable, multiple communication channels each coupled with a corresponding flash memory is preferred though in some circumstances a single flash memory and a single corresponding communication channel may be sufficient where the volume of data to offload is small. The multiple communication channels and corresponding flash memory components may temporally overlap operations (e.g., operate substantially in parallel) to provide required performance in the offloading of cached data.

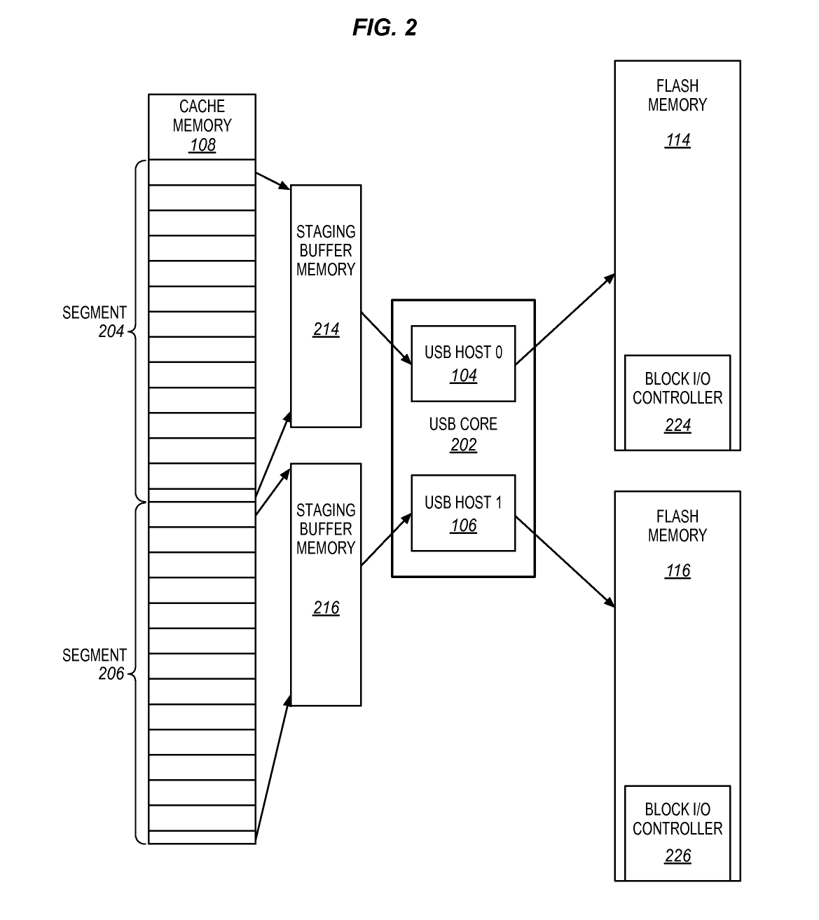

FIG. 2 is a block diagram describing exemplary additional details of controller 100 of FIG. 1. Upon detecting an impending loss of power to the controller, dirty data in cache memory 108 is divided into two or more segments/portions 204 and 206. Each segment (204 and 206) is associated with a corresponding staging buffer memory 214 and 216, respectively. Further, each segment and staging buffer memory is associated with a corresponding communication channel (USB host 104 and USB host 106, respectively, of USB core logic 202). Still further, each communication channel (104 and 106 of USB core 202) is coupled with a corresponding flash memory 114 and 116, respectively. As noted above, in some embodiments, each flash memory 114 and 116 comprises a corresponding block I/O controller 224 and 226, respectively. The block I/O controller of each flash memory device provides an interface (e.g., a USB interface) for its respective flash memory and presents the storage capacity of its respective flash memory as a block oriented device (e.g., as a disk drive). In such a block oriented device, each block of the flash memory may be addressed by an associated block address (e.g., logical block address—LBA). Further, some block I/O controller components may allow user definition of the size of each block to accommodate particular custom applications such as the features and aspects herein to format a simple “file system” on the flash memories. So-called “thumb-drives” (well-known and widely available) may provide the desired structure for flash memories 114 and 116. It is desirable that the component used provides a block I/O interface such as a standard disk drive. Some “thumb-drives” are restricted such that they require installation of some industry standard file system before they may be used. Such a thumb-drive may be inappropriate for this application in that a simple “file system” structure is preferred to the complexity of most industry standard file systems (i.e., a simple block I/O interface is preferred so that a simple, customized, low overhead “file system” may be used by controller 100.

In operation, control logic of the storage controller (e.g., logic 102 of controller 100 of FIG. 1) first copies cached data segment 204 into staging buffer memory 214 along with corresponding header information that serves to identify the number of blocks of data in the segment as well as other information related to the structure of the segment as it will be stored in the flash memory. Further, in some embodiments, each block of cached data copied from segment 204 may include a corresponding error detection and correction code value as it is stored in staging buffer memory 214 and as it will be stored in the corresponding flash memory 114. For example, if circuits of the storage controller supports such computations, a SCSI data integrity field (DIF) value (or other error detection and correction code values) may be used to validate the integrity of each block of data in the staging buffer memory 214 as well as in corresponding flash memory 114 when the segment is transferred through communication channel 104. It is preferred that the circuitry of the storage controller provide assistance for such error code computation since the offload process must proceed very quickly to complete in a very short period of time before power is totally lost to the controller. In like manner, cached data from segment 206 and associated header information and error detection and correction information is transferred first to staging buffer memory 216 and then through second communication channel 106 for storage in flash memory 116 utilizing its corresponding block I/O controller 226.

Those of ordinary skill in the art will recognize numerous additional and equivalent elements present in a fully functional storage controller 100 of FIGS. 1 and 2. Such additional and equivalent elements are omitted herein for simplicity and brevity of this discussion.

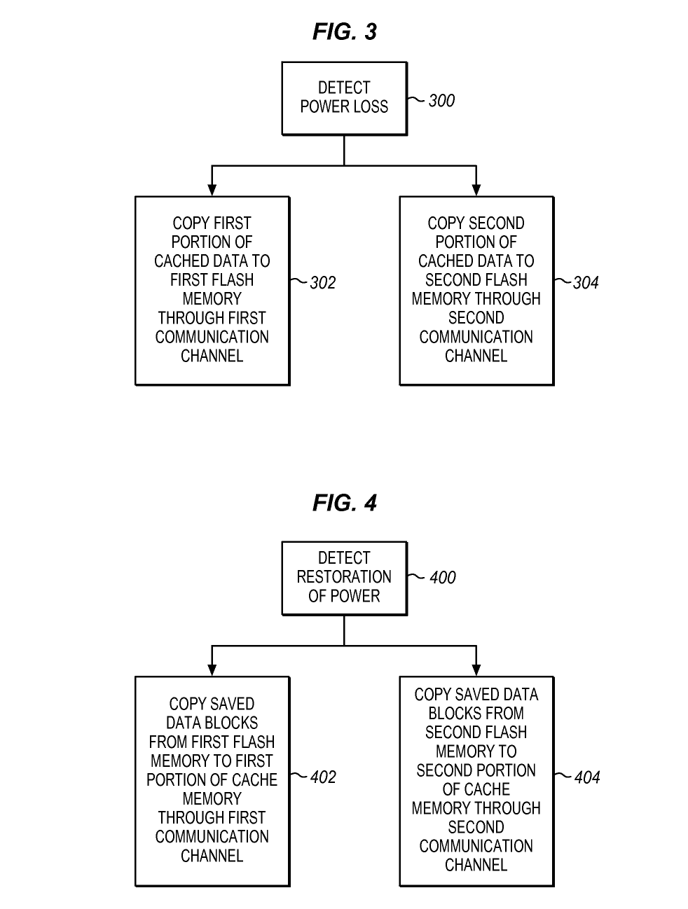

FIG. 3 is a flowchart describing an exemplary method for copying (“offloading”) cached data from a volatile cache memory of the storage controller into a nonvolatile flash memory storage controller responsive to detection of a power loss. The method of FIG. 3 may be performed by suitable control logic of a storage controller such as control logic 102 of controller 100 of FIGS. 1 and 2. At step 300, the storage controller's control logic detects a loss of power (e.g., an impending loss of power applied to the storage controller). As noted above, well known techniques may be utilized to sense such a power loss. For example, a simple comparator circuit may determine that the voltage of the power applied to the storage controller has dropped below a predefined threshold typically indicative of an impending total loss of power. Upon sensing such a drop of voltage, the comparator circuit may generate a signal applied to the control logic indicating the detection of an impending loss of power to the storage controller. Responsive to sensing such an impending power loss, steps 302 and 304 are operable substantially in parallel (i.e., substantially overlapping temporally). Step 302 copies a first portion of cached data from the volatile cache memory into a first flash memory of the storage controller utilizing a corresponding first communication channel. In like manner, step 304 copies a second portion of the cached data in volatile memory to a second flash memory utilizing a corresponding second communication channel. As noted above, the two method steps are operating with substantial temporal overlap utilizing the parallel operation capabilities of multiple communication channels each coupled with a corresponding independent flash memory. By so dividing the process of copying the data from volatile memory to nonvolatile memory, the task of offloading (copying) the cached data may proceed quickly enough to complete before total loss of power to the storage controller. In some embodiments, where the volume of cached data is particularly small, a single processing step (e.g., 302 or 304) may be employed to copy all the cached data from the volatile memory to nonvolatile memory utilizing only a single communication channel and a corresponding single flash memory. However, in most practical applications, the volume of data to be offloaded will be substantial enough to require multiple channels and multiple corresponding flash memory components—and thus multiple steps operating in parallel. Further, the period of time during which sufficient power is still available to operate the storage controller will be very short and thus speed of the offload processing steps is critical. Thus, in the best-known mode of practicing features and aspects hereof, two or more temporally overlapping processing steps utilizing corresponding multiple communication channels and flash memories is preferred to assure completion of the offloading process before power loss prevents further operation of the storage controller. Header (metadata) is stored in the flash memory (as discussed further herein below) to indicate whether the offload process commenced and whether the process completed properly. Further exemplary details of processing of steps 302 and 304 are provided herein below.

FIG. 4 is a flowchart describing another exemplary method in accordance with features and aspects hereof to restore information previously offloaded from the volatile memory into the nonvolatile memory. The method of FIG. 4 may be performed by any suitable control logic of the storage controller such as control logic 102 of controller 100 of FIG. 1. At step 400, the storage controller's control logic detects a restoration of power to the storage controller. Restoration of power may be detected by simply resuming operation of the storage controller when power is applied and detecting that an earlier power loss has occurred. For example, a previous power loss may be detected by sensing that the nonvolatile memory indeed has offloaded cached data stored therein. A suitable timestamp, validity flag, or other indicia in the nonvolatile memory may be inspected to make such a determination. Responsive to detecting restoration of power, steps 402 and 404 are operable substantially in parallel (e.g., substantially overlapping temporally) to restore data offloaded to the nonvolatile memory back into the volatile cache memory. Specifically, step 402 determines the validity of the header block (e.g., using the associated error detection and correction code value) and, if valid, determines the number of data blocks present in the flash memory. If the header block is found to be invalid, the duplicate copy of the header block may be used. Redundant header blocks help assure that invalid contents of the copied cache data cannot be processed on a later restart (restoration of power). It is also possible that the header blocks have valid information but indicate that the offload process was not completed. As noted later herein, the process to write to the flash memory devices is structured such that the header blocks are updated before the offload procedure commences (to indicate that the processes has commenced but that no data is yet offloaded) and after the offload process successfully completes (to indicate the number of blocks of data successfully offloaded from cache memory to the flash memory. Thus, if the offload process failed to complete, both header blocks will be invalid (e.g., indicate no data was successfully offloaded). In such a case, an appropriate message or signal may be generated to inform a user that no cached data can be recovered—and hence appropriate other backup restoration may be required). If only one of the header blocks is invalid, it is more likely that the offload process completed but the flash memory component has an error in its storage and retrieval of some portion of the header block. Assuming one of the two header blocks is validated, step 402 copies data blocks from the first flash memory back into a first portion of the cache memory utilizing a corresponding first communication channel. As each data block is retrieved, its corresponding error detection and correction code may be retrieved to validate the retrieved data. If valid, the data block is copied back to its proper location in the volatile cache memory (e.g., to a location indicated by metadata stored with each block of offloaded data). Invalid data blocks are skipped so that as much valid data as is found in the flash memory is restored to the volatile cache memory. If any invalid blocks are detected, an appropriate error signal may be applied to the control logic to indicate that the entire cache memory was not restored. In like manner, step 404, substantially temporally overlapping the processing of step 402, restores saved data blocks from the second flash memory to a second portion of the volatile cache memory utilizing a second communication channel.

Since the restoration processing of FIG. 4 is performed with normal power available to the storage controller, it is not necessary to utilize the multiple communication paths in parallel. Rather, in some embodiments, steps 402 and 404 may be performed sequentially if so desired since normal power is available for continued operation of the storage controller. However, since logic is available to perform the restoration process of steps 402 and 404 substantially in parallel, the restoration process may proceed more quickly. Such a design choice will be readily apparent to those of ordinary skill in the art.

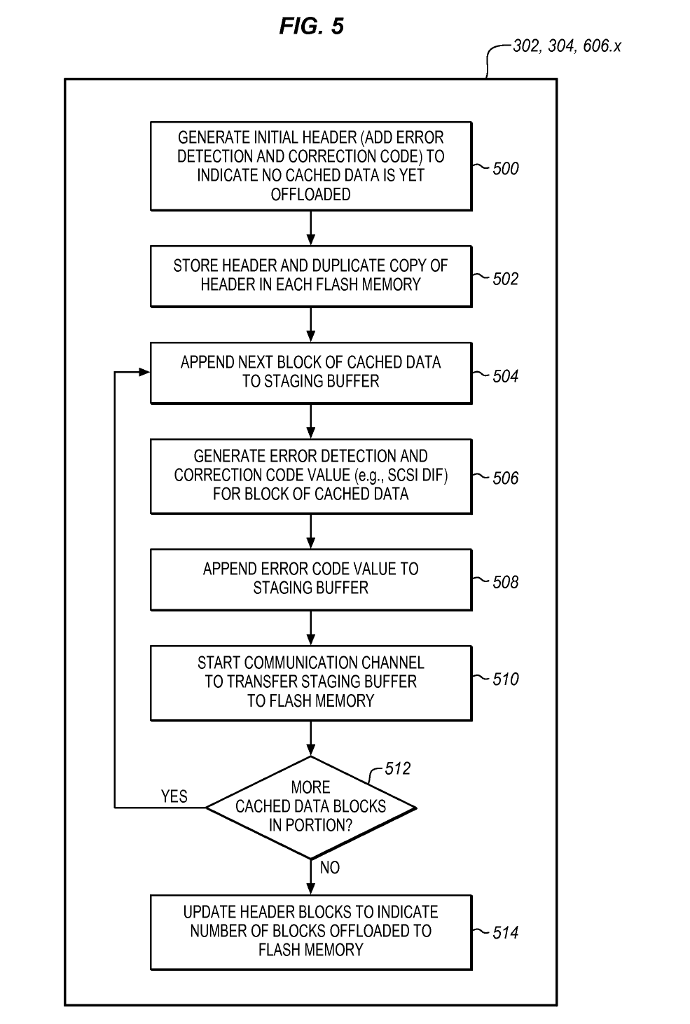

FIG. 5 is a flowchart describing exemplary additional details of the processing of each of steps 302 and 304 of FIG. 3. As noted above, steps 302 and 304 are substantially identical performing identical processing for different portions of the cached data using different flash memories, staging buffers, and communication channels. FIG. 5 therefore represents the generalized processing of either step 302 or step 304 without specific reference to a particular first or second staging buffer, first or second communication channel, or first or second flash memory. At step 500, control logic of the storage controller generates a header block comprising indicia of the number of blocks of cached data in the portion to be copied into flash memory. In some embodiments, the header block may also include an appropriate error correction detection and correction code value to validate the header block. The initial header block information may comprise a timestamp or other version/sequence indicator as well as indicia of the number of blocks of cached data offloaded (i.e., zero at the time of commencing the offload). Step 502 then stores the generated header block and a duplicate copy of the generated header block into each flash memory device (via its corresponding channel). Step 504 through 510 are then iteratively operable to copy the blocks of cached data corresponding to the portion to be offloaded into a staging buffer for transfer to a corresponding flash memory. Specifically, step 504 appends a next block of cached data into the staging buffer. Step 506 then generates an error detection and correction code value for the appended next block of cached data. As noted above, SCSI DIF values or other suitable error detection and correction code values may be utilized for each block of cached data. The block of cached data is stored in the staging buffer along with appropriate metadata indicating where the cached data was located in the cache memory so that it can be restored to the proper location when power is restored. At step 508, control logic adds the generated error detection and correction code value to the staging buffer along with the corresponding data block and its associated metadata. Step 510 then starts operation of the corresponding communication channel to transfer the block of cached data information structured in the staging buffer with associated metadata and error codes into the corresponding locations of the nonvolatile flash memory. Step 512 then determines whether additional cached data blocks in the portion to be offloaded remain to be processed. If so, processing loops back to step 504 to repeat processing until all blocks of data in the portion to be offloaded have been processed. If step 512 determines that all blocks of cached data have been processed, step 514 updates the header blocks (both copies) to indicate the total number of blocks of cached data successfully offloaded from the cache memory to the flash memory.

Those of ordinary skill in the art will readily recognize other design choices for structuring the information in the staging buffer and thus the information transferred to flash memory. For example, the various error detection and correction codes may be appended to the staging buffer contiguous with the corresponding block of data with which the error detection and correction code is associated. In other embodiments, all the error detection and correction code values may be aggregated into a separate reserved area of the staging buffer and hence stored in a reserved area of the corresponding flash memory. Further, the metadata stored with each block of cached data may indicate contiguous locations in cache memory from which the cached data was retrieved. In other embodiments, the metadata may comprise information identifying non-contiguous locations from which the cached data in the staging buffer was retrieved. These and other design choices will be readily apparent to those of ordinary skill in the art.

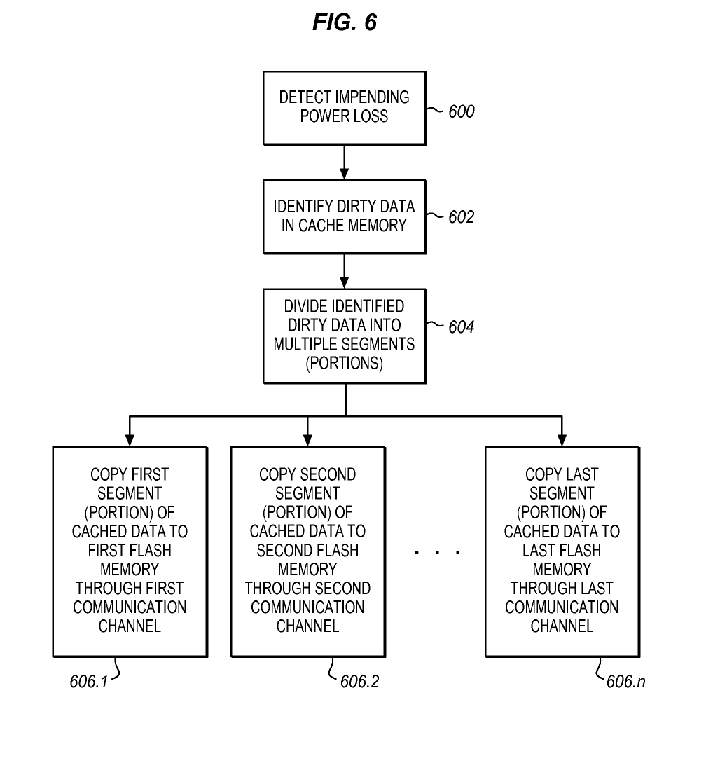

FIG. 6 is a flowchart describing another exemplary method in accordance with features and aspects hereof to offload (copy) blocks of dirty cached data from the volatile cache memory into nonvolatile flash memory responsive to detection of a power loss. The method of FIG. 6 may be performed utilizing any suitable control logic of the storage controller such as control logic 102 of controller 100 of FIGS. 1 and 2. Step 600 detects an impending power loss utilizing methods and circuitry similar to that described above with respect to step 300 of FIG. 3. Step 602 identifies all dirty data in the volatile cache memory. Since there is a limited, short period of time (due to impending power loss) in which to copy data from the volatile cache memory to the nonvolatile flash memory, in the best-known mode of practicing features and aspects hereof, only dirty cached data need be offloaded. As noted above, dirty cached data is data written to the volatile cache memory but not yet posted or flushed to the persistent storage of the storage devices coupled with the storage controller. Having identified all such dirty data, step 604 next divides the identified dirty data into multiple segments or portions. Each segment or portion will comprise essentially a similar amount of dirty cached data blocks. Step 606.1 through 606.n are then operable substantially in parallel (e.g., substantially overlapping temporally) to copy each of the identified segments or portions into a corresponding flash memory through a corresponding communication channel. Exemplary additional details of the processing of each of steps 602.1 through 602.1 are as discussed above with respect to FIG. 5. As noted above, multiple flash memories and corresponding multiple communication channels permit rapid transfer of the identified dirty cached data from the volatile memory into the nonvolatile memory. At least two such parallel channels and flash memories are preferred however any suitable number may be implemented as a matter of design choice.

Those of ordinary skill in the art will recognize that the identified dirty blocks of cached data may be noncontiguous. Processing of step 604 to divide the dirty data into multiple segments may determine the total number of all such identified dirty blocks of data and divide by number of parallel operable channels and corresponding flash memories to determine the size of each segment or portion (a size in number of blocks per segment/portion). Further, step 604 may construct a corresponding scatter/gather list for each identified segment or portion to permit the processing of steps 606.1 through 606.n to utilize direct memory access (DMA) techniques incorporating the generated scatter/gather lists to copy noncontiguous blocks of dirty cached data in its segment or portion into the staging buffers.

Those of ordinary skill in the art will readily recognize numerous additional and equivalent steps that may be performed in fully functional methods such as methods of FIGS. 3 through 6. Such additional and equivalent steps are omitted here and for simplicity and brevity of this discussion.

Methods for offloading cached data blocks from volatile memory to multiple flash memories utilizing multiple parallel indication channels must be performed rapidly as noted above given the limited time that sufficient power may be available to operate the storage controller. In the best-known mode of practicing features and aspects thereof, the offloading process may be implemented as suitably designed custom circuits implementing a state machine model for transferring each segment or portion of cached data into the corresponding staging buffer and thence into the corresponding flash memory.

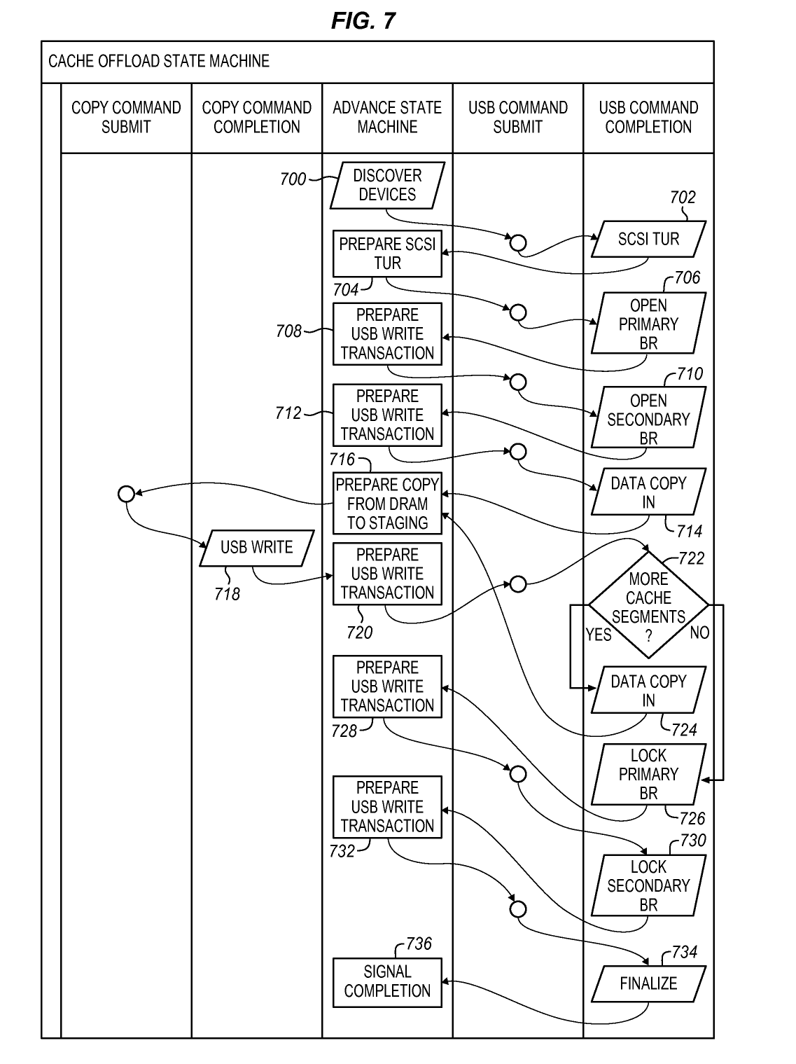

FIG. 7 is a block diagram describing an exemplary state machine model for such an implementation. In the representation of FIG. 7, a state is identified as a slanted parallelogram, a process that may cause a state transition is identified as a rectangle, and the wait for an in asynchronous event completion (e.g., completion of a process) is indicated as a small circle. The various labeled columns of FIG. 7 represent relative portions of the control logic where the corresponding processes, states, and event completion waits may occur. State 700 represents an initial state of processing initiated responsive to detection of an impending power loss. Initial processing comprises discovering the number of flash memory devices and corresponding communication channels available for use in offloading data in the volatile cache memory into nonvolatile flash memory. As noted herein, some exemplary embodiments may require only a single flash memory device (and a corresponding single communication channel) such as where the volume of data to be offloaded is small. Other exemplary embodiments where the volume of data to offload is larger may require two or more flash memory devices (and a corresponding number of communication channels) to achieve the required offloading bandwidth in a short period of time before power is totally lost. Thus, at state 700 the number of flash memory devices is determined and the control logic configures itself for further operation accordingly. Processing to discover the number of such devices, when completed, transitions to State 702 in which the readiness of the particular flash memory and communication channel is determined Process 704 preparers a SCSI test unit ready (TUR) command to determine the present state of readiness of the communication channel and corresponding flash memory component. When the communication channel and flash memory are determined to be ready, the state machine transitions to State 706 at which a “primary boot record” (i.e., primary copy of a header block in the flash memory) is opened (i.e., readied for updating). Process 708 then preparers and transmits a write transaction over the communication channel (e.g., a USB write transaction) to update/initialize the primary boot record. As noted above the header portion (boot record) may comprise other suitable fields and values to describe the structure of the segment to be copied into the corresponding flash memory. The initial header block (primary boot record) may indicate an updated timestamp (or any suitable indicia as the version) and indicate the number of blocks of offloaded cached data in the corresponding flash memory device (i.e., presently zero when the process commences). Following completion of the generated write transaction, the state machine enters state 710 at which the secondary boot record (i.e., a duplicate copy of the header block) is readied for updating. Process 712 then preparers a corresponding write transaction (e.g., USB write transaction) to update/initialize the duplicate header block (the secondary boot record). Upon completion of the write transaction to the secondary boot record, the state machine enters state 714 to prepare for copying of the data blocks for this portion or segment. Process 716 then prepares a copy command for the control logic to copy a first portion of cached data from the volatile cache memory of the storage controller into an appropriate location of the staging buffer. As noted above, if the controller circuitry provides suitable assist logic, the copy process may include not only copying the data of the cached data block but may also comprise generation and storage of the corresponding error detection and correction code value (e.g., SCSI DIF value) to be transferred into the staging buffer and thence to the flash memory. As further noted above, a DMA scatter/gather list may be used to transfer non-contiguous blocks of data of the first portion from the volatile cache memory to the staging buffer. Further, the block of cached data as stored in a staging buffer may comprise metadata indicating a location in the cache memory from which the block of cached data was retrieved. Such metadata is useful when restoring the offloaded cached data from flash memory back into the proper locations in cache memory. Upon completion of the generated copy command, the state machine enters state 718 to generate and perform a corresponding write of the information into the flash memory. Process 720 then prepares and initiates an appropriate write transaction on the communication channel (e.g., a USB write transaction) to transfer the cached data block (with location related metadata and corresponding error detection and correction code if any) from the staging buffer to the flash memory. Upon completion of the write transaction to the flash memory, decision block 722 then determines whether more data remains to be copied from the cache to the flash memory. If so, the state machine transitions to state 724 and continues looping through 716, 718, 720, 722, and 724 until all data has been successfully copied from cache memory to the flash memory (through the intermediate staging buffer). Elements 716 through 724 may be duplicated to operate substantially in parallel for each flash memory device, each using its associated communication channel. The staging buffer allows rapid construction of a large memory block copied from the cache memory according to a scatter/gather list (e.g., from non-contiguous blocks of the cache memory). The contiguous memory of the staging buffer (one for each flash memory device and associated channel) then allows the write transaction to the flash memory (e.g., a USB write transaction) to proceed at the fastest rate possible for the communication channel (typically much slower than the copy from the cache memory to the staging buffer).

When all processing of elements 716 through 724 have completed (i.e., all desired cache memory content has been copied to flash memory), the state machine transitions to state 726 to prepare the header blocks for update. Process 728 then prepares and performs another write transaction on the channel to update the header block (the primary boot record). The header blocks are updated to indicate the total number of blocks of cached data successfully offloaded from the cache memory to the flash memory. Following the update of the primary boot record, state 730 and process 732 likewise update the secondary boot record. Following update of both boot records (both header blocks in all flash memory devices), the state machine transitions to state 734 and process 736 signals completion of the offload process. It is desirable that the header block (primary boot record) and duplicate header block (secondary boot record) be updated sequentially to help assure that at least one of the header blocks (e.g., the primary boot record) is updated correctly in case power is totally lost before the duplicate (e.g., secondary boot record) is properly updated.

Those of ordinary skill in the art will recognize that the state machine description above describes essentially the processing for one of potentially multiple flash memories and corresponding communication channels. As noted in the above description, the core processing of elements 716 through 724 is duplicated for each of multiple flash memory devices and corresponding communication channels. In some exemplary embodiments, the entire state machine logic may be replicated for each of such multiple flash memory devices and channels. In other exemplary embodiments, portions of the logic relating to processing of the header blocks in each of the multiple channels may proceed sequentially since they represent a relatively small portion of the overall processing. In like manner, copying of blocks of cached data from the cache memory to the staging buffers for each of the multiple channels may also proceed sequentially and share use of a DMA controller to copy a first portion to a first staging buffer using a corresponding scatter/gather list followed by a second, etc. Again, the DMA processing for such memory to memory copies is a relatively small portion of the total time in processing of the state machine. The write transactions to transfer the content of each staging buffer to its corresponding flash memory through its associated channel are the bulk of the time consumed by the offload processing state machine. Thus, where multiple flash memory devices and corresponding channels are employed, the corresponding write transactions should overlap temporally (i.e., in parallel) to help assure that the offload processing completes within the very short time period before power is completely lost to the controller.

While the invention has been illustrated and described in the drawings and foregoing description, such illustration and description is to be considered as exemplary and not restrictive in character. One embodiment of the invention and minor variants thereof have been shown and described. In particular, features shown and described as exemplary software or firmware embodiments may be equivalently implemented as customized logic circuits and vice versa. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A storage controller comprising:
a cache memory;
control logic coupled with the cache memory and adapted to couple with one or more storage devices, the control logic adapted to process I/O write requests received from an attached host system by storing write data associated with the write I/O request in the cache memory;
a first flash memory device;
a first communication channel coupling the first flash device with the control logic;
a second flash memory device; and
a second communication channel coupling the second flash device with the control logic;
wherein the control logic is further adapted to detect impending loss of power to the storage controller,
wherein the control logic is further adapted, responsive to detecting the impending loss of power, to copy a first portion of data in the cache memory to the first flash memory device through the first communication channel and to copy a second portion of the write data in the cache memory to the second flash memory device through the second communication channel wherein communications through the first and second communication channels substantially overlap temporally.

2. The controller of claim 1
wherein the first flash memory device further comprises a first block I/O controller for writing the first portion as one or more blocks of data on the first flash memory device, and
wherein the second flash memory device further comprises a second block I/O controller for writing the second portion as one or more blocks of data on the second flash memory device.

3. The controller of claim 1 further comprising:
a first staging buffer memory coupled with the control logic; and
a second staging buffer memory coupled with the control logic,
wherein the control logic is further adapted to copy the first portion by copying the first portion to the first staging buffer memory and then copying the data in the first staging buffer memory to the first flash memory device,
wherein the control logic is further adapted to copy the second portion by copying the second portion to the second staging buffer memory and then copying the data in the second staging buffer memory to the second flash memory device.

4. The controller of claim 3
wherein the control logic is further operable to store a first header block in the first staging buffer memory to be copied to the first flash memory device wherein the first header block comprises a number of blocks of cached data that comprise the first portion, and
wherein the control logic is further operable to store a second header block in the second staging buffer memory to be copied to the second flash memory device wherein the second header block comprises a number of blocks of cached data that comprise the second portion.

5. The controller of claim 4
wherein the control logic is further operable to store a duplicate copy of the first header block in the first staging buffer memory to be copied to the first flash memory device, and
wherein the control logic is further operable to store a duplicate copy of the second header block in the second staging buffer memory to be copied to the second flash memory device.

6. The controller of claim 5
wherein the control logic is adapted to add an error detection and correction code value to each block of cached data that comprises the first portion and to each block of cached data that comprises the second portion and to the first header and to the second header and to the duplicate copy of the first header and to the duplicate copy of the second header.

7. The controller of claim 6
wherein the error detection and correction code value is a small computer systems interface (SCSI) data integrity field (DIF) value.

8. The controller of claim 1
wherein the first and second communication channels are each universal serial bus (USB) communication channels.

9. The controller of claim 1
wherein the control logic is further adapted to detect restoration of power to the storage controller, and
wherein the control logic is further adapted, responsive to detecting the restoration of power, to restore the first portion from the first flash memory device to the cache memory and to restore the second portion from the second flash memory device to the cache memory.

10. A method operable in a storage controller having a cache memory used by the controller to store write data associated with write requests received by the controller from an attached host, the method comprising:
detecting an impending power loss to the controller;
responsive to detecting the impending power loss, performing the additional steps of:
copying a first portion of data in the cache memory to a first flash memory device through a first communication channel coupling the controller with the first flash memory device;
copying a second portion of data in the cache memory to a second flash memory device through a second communication channel coupling the controller with the second flash memory device wherein the copying of the first portion and the copying of the second portion substantially overlap temporally.

11. The method of claim 10 wherein the storage controller further comprises a first staging buffer memory and a second staging buffer memory,
wherein the step of copying the first portion further comprises copying the first portion to the first staging buffer memory and then copying the first staging buffer memory to the first flash memory device, and
wherein the step of copying the second portion further comprises copying the second portion to the second staging buffer memory and then copying the second staging buffer memory to the second flash memory device.

12. The method of claim 11
wherein the step of copying the first portion further comprises storing a first header block in the first staging buffer memory and then adding the first portion to the first staging buffer memory, wherein the first header block comprises a number of blocks of cached data that comprise the first portion, and
wherein the step of copying the second portion further comprises storing a second header block in the second staging buffer memory and then adding the second portion to the second staging buffer memory, wherein the second header block comprises a number of blocks of cached data that comprise the second portion.

13. The method of claim 12
wherein the step of copying the first portion further comprises storing a duplicate copy of the first header block in the first staging buffer memory, and
wherein the step of copying the second portion further comprises storing a duplicate copy of the second header block in the second staging buffer memory.

14. The method of claim 12
wherein the first header block further comprises an error detection and correction code value,
wherein the second header block further comprises an error detection and correction code value,
wherein the step of copying the first portion further comprises adding an error detection and correction code value to each block of cached data in the first staging buffer memory, and
wherein the step of copying the second portion further comprises adding an error detection and correction code value to each block of cached data in the second staging buffer memory.

15. The method of claim 14
wherein the error detection and correction code value is a small computer systems interface (SCSI) data integrity field (DIF) value.

16. The method of claim 10
wherein the first and second communication channels are each universal serial bus (USB) communication channels.

17. The method of claim 10 further comprising:
detecting restoration of power to the storage controller, and
responsive to detecting the restoration of power, restoring the first portion from the first flash memory device to the cache memory and to restoring the second portion from the second flash memory device to the cache memory.

18. A method operable in a storage controller having a cache memory used by the controller to store write data associated with write requests received by the controller from an attached host, the controller further having multiple staging buffer memories each communicatively coupled with a corresponding flash memory device through a corresponding communication channel, the method comprising:
detecting an impending power loss to the controller;
responsive to detecting the impending power loss, performing the additional steps of:
identifying all dirty data presently in the cache memory;
dividing the identified dirty data into multiple segments each segment comprising a substantially similar number of blocks of dirty data, each segment associated with a corresponding staging buffer memory of the multiple staging buffer memories;
for each segment, performing the additional steps of:
storing a header block in the corresponding staging buffer memory, the header block comprising indicia of the number of blocks of dirty data in the segment that follow the header block;
for each block of dirty data in the segment, performing the steps of:
generating an error detection and correction code value corresponding with the block of dirty data; and
appending the block of dirty data and the error detection and correction code value to the staging buffer memory; and
copying the staging buffer memory to the corresponding flash memory device through the corresponding communication channel,
wherein processing of the multiple segments substantially overlaps temporally.
